(19) United States
(12) Patent Application Publication
(10) Pub. No.: US 2016/0267423 A1
(43) Pub. Date: Sep. 15, 2016

(54) SYSTEMS AND METHODS FOR MOBILE WORKFORCE MANAGEMENT SYSTEM TRUSTED AGENT WORK ORDER PROCESSING

(71) Applicant: Trapeze Software ULC, Mississauga (CA)

(72) Inventors: Bradley BRAUN, Calgary (CA); Phil ARSENAULT, Calgary (CA); Kyle BROWN, Calgary (CA)

(21) Appl. No.: 15/063,890

(22) Filed: Mar. 8, 2016

Related U.S. Application Data
(60) Provisional application No. 62/130,319, filed on Mar. 9, 2015.

(51) Int. Cl. G06Q 10/06; G06F 21/62; H04L 29/06

(52) U.S. Cl. CPC G06Q 10/063112; H04L 63/20; G06F 21/6245

(57) ABSTRACT

Systems and methods for mobile workforce management system (WMS) trusted agent work order processing are presented whereby an agency requiring extra workforce resources of a third party provider (TPP) to perform and process work orders is granted TPP-appropriate limited access to work order data, uses its own TPP system in accord with its TPP workflows, and the TPP system workflows are translated back into WMS work order data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Mobile workforce management systems (MWM) allow an agency to enable mobile work order processing (e.g. mobile workers completing and entering data related to work orders), greatly increasing efficiencies in completing work orders. However, occasionally an agency does not have the required resources to complete work orders in a timely fashion. The agency may then hire a third party provider (TPP) to perform some or all of one or more work orders. Because the third party provider is not part of the agency, they do not have access to the agency's MWM so they cannot maintain the same efficiencies and historically paper processing or manual data translation has been employed by one or both of the agency and TPP. Simply providing them access, even if technically possible, creates confidentiality, competition, and security challenges. Additionally, most TPPs have some form of internal system that the TPP requires their mobile workforce to continue to use—without being encumbered by having to use two systems.

There thus remains a need for a MWM that allows TPPs to complete work orders while addressing the shortcomings in current approaches.

### SUMMARY OF THE INVENTION

There is a method for contractor agency performance of work orders on behalf of an agency, where such work orders comprise viewable data in viewable data fields, editable data in editable data fields, confidential data in confidential data fields, and work order data in confidential fields, the method comprising: checking whether a contractor agency can perform a work order, displaying the work order on a contractor agency planning grid viewable by the contractor agency via a contractor agency fleet management system, via creating an assigned work order from the work order, if the contractor agency can perform the work order, the creating further comprising: sending viewable data in viewable data fields and editable data in editable data fields to the contractor agency planning grid; obfuscating confidential data in confidential data fields on the contractor agency planning grid; and removing work order data in confidential fields from the contractor agency planning grid.

The method may further comprise: receiving modifications to the assigned work order; verifying the modifications to the assigned work order; and amending the work order by conforming it to the assigned work order.

The method may further comprise noting the work order as completed and limiting further viewing of the work order.

The method may further comprise: displaying the status of the work order, prior to the noting, by displaying the work order or assigned work order according to user access rules.

The creating may further comprise mapping the work order to the assigned work order via one or more work order mapping dictionaries.

There is further a system for contractor agency performance of work orders on behalf of an agency where such work orders comprise viewable data in viewable data fields, editable data in editable data fields, confidential data in confidential data fields, and work order data in confidential fields, the system comprising: a contractor agency planning grid viewable by a contractor agency via a contractor agency fleet management system and configured to display an assigned work order from a workforce management system; and the workforce management system comprising a processor configured to: check whether the contractor agency can perform a work order; assign the work order to the contractor agency planning grid, comprising creating the assigned work order from the work order if the contractor agency can perform the work order, the creating further comprising: sending viewable data in viewable data fields and editable data in editable data fields to the contractor agency planning grid; obfuscating confidential data in confidential data fields on the contractor agency planning grid; and removing work order data in confidential fields from the contractor agency planning grid.

The contractor agency planning grid may be further configured to receive modifications to the assigned work order; and the workforce management system is further configured to verify the modifications to the assigned work order, and amend the work order by conforming it to the assigned work order.

The work order may be noted as completed, and further viewing of the work order may be limited.

Prior to the work order being noted as completed, the work order and the assigned work order may be displayed according to user access rules.

The workforce management system may be further configured to map the work order to the assigned work order via one or more work order mapping dictionaries.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for trusted agent work order processing for mobile workforce management systems according to a non-limiting embodiment of the present invention;

FIG. 2 is a diagram of a method for trusted agent work order processing for mobile workforce management systems according to a non-limiting embodiment of the present invention;

FIG. 3 is a diagram of a screenshot for trusted agent work order processing for mobile workforce management systems according to a non-limiting embodiment of the present invention; and

FIG. 4 is a diagram of a further method for trusted agent work order processing for mobile workforce management systems according to a non-limiting embodiment of the present invention; and

FIG. 5 is a diagram of a screenshot for mapping work order data between an agency and a contractor agency according to a non-limiting embodiment of the present invention.

### DETAILED DESCRIPTION OF THE INVENTION

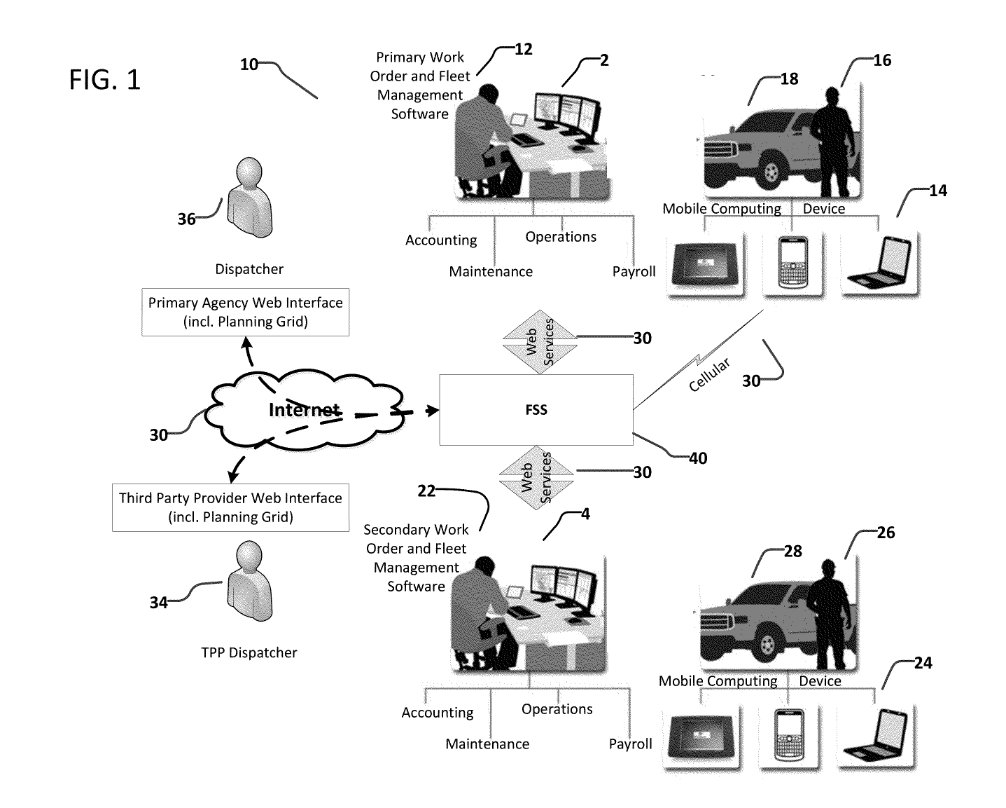

FIG. 1 is a diagram of a system 10 for trusted agent work order processing for mobile workforce management systems (WMS).

Fleet operator 2 may have one or more fleet vehicles to perform jobs or work orders on behalf of customers. Fleet operator 2 may have various components to perform its functions, including enterprise resource planning (ERP) software 12 (which may include accounting, maintenance, operations, payroll and the like) a WMS or field service solution (FSS) 40 which may comprise software in the office or accessible in the office and/or by dispatchers, a mobile computing device with integrated global positioning system (GPS) in the vehicle and a cellular and/or satellite connection that exchanges data between the vehicle and the office via communication network 30. Fleet operator 2 may have a dispatcher 36 that can access functionality of WMS 40 to, for example, assign work orders to operator 16 or TPP Dispatcher 34 from Agency 4. It is to be understood that various elements of system 10 may comprise computer-related technology (such as processors, volatile and non-volatile storage, network communication interfaces, and the like). WMS may also comprise asset tracking systems and integrate with, or include, ERP software 12, though such components may be separate.

The WMS 40 may allow office staff to know the location of all field service operators 16 and can send the closest or most appropriate operator to a job, and operators can complete more tickets (work orders) per day. WMS may allow work orders, field tickets and work orders to be electronically dispatched to the appropriate field operator automatically via Mobile Computing Device (MCD) 14—instead of relying on staff (that may be located at head office where WMS servers may be located) having to email or print out. Work flows smoothly and efficiently from dispatchers to field operators or drivers and back to the office/WMS, such as via being input into MCD 14 and transmitted back and/or synchronized. Electronic manifests may record jobs, trips, calls and pickups, and may be a paperless way to ensure jobs are completed as quickly and accurately as possible. Office staff and dispatchers can easily change manifests or work orders throughout the day without having to contact the driver or field operator 16. Field operator 16 can then respond to the changes and perform the revised manifest. Work orders may be completed by field operators as they do their job (such as via MCD-A on MCD 14) improving accuracy and efficiency and eliminates misplaced paperwork. Billing cycles are also greatly reduced and payroll processes are improved. Having all field operators' work order information electronically recorded—from login to logoff—ensures accurate payroll and eliminates unnecessary overtime hours. Work orders are completed and updated in your back office system in real-time, leading to much faster billing and invoicing, speeding payment cycles by up to three months for most operations. Exemplary FSS 40 may be AssetWorks™ Field Service Solutions™.

Asset tracking systems may include mobile computing devices with integrated GPS. Asset tracking systems may further enable monitoring of any fixed or mobile asset in the field via location providing devices located thereon (such as with embedded GPS) (not shown). This technology can also be used to enhance journey management programs.

Fleet vehicle 18 is a vehicle that provides, or relates to the provision of, fleet services (which may vary depending on the purpose of the fleet). Fleet vehicle 18 may include cars, trucks, vans, buses, forklifts, farm equipment, and/or other specialty equipment. Fleet vehicle 18 may have many systems running thereon, as known in the art, such as engines, brakes, audio announcement technology, MCD 14, signage, special work order processing equipment, and the like (each a “fleet vehicle system”, not shown).

Mobile computing devices (MCD) 14/24 may be a computing device that may display user interface elements relating to functionality of system 10 and accept user input (such as keystrokes, clicks, touch inputs, and the like). MCD 14 may often be located on fleet vehicle 18, but may be removable therefrom. Exemplary MCDs 14 include mobile phones, tablets, laptops (that may be running Windows™ or iOS™ operating systems, for example), ruggedized laptops, vendor specific MDTs (such as Android™. Blackberry™ or Apple™ products). Each of these combinations of vendor and product type (laptop versus smartphone for example) may be considered a hardware platform for MCD 14. Operators of fleet vehicle 18, or supervisors, may be some of the primary users of MCDs 14. MCD 14 may communicate with other elements of system 10 (such as field service solution, FSS, 40), fleet vehicle 18, kiosks, and the like, which may be referred to herein as fleet agency elements), for example via communication network 30. MCDs 14 may have GPS units therein, allowing the GPS location of MCD 14 to be determined (which may be referred to as an MCT GPS location).

MCD 14 may be operated by a driver of fleet vehicle 18. MCD 14 (such as via MCD-A) may provide and/or allow a driver to provide the functionality described herein.

MCD-A is an application residing on MCD 14. MCD-A largely controls MCD 14, including its operation and communication with other aspects of system 10. MCD-A may be configured to present one or more screens (which may include output and input user interface elements) to a user of MCD 14, or otherwise accept or provide input or output (such as via sounds, vibrations, and the like) to enable to functionality described herein.

MCD, with MCD-A, may ensure operators 16 do not get lost and have to waste fuel driving extra distance. It also eliminates the need for paper maps, which saves time and improves safety. Well sites or legal sub-division (LSD) coordinates can be uploaded to in-vehicle or mobile devices and field operators are directed to their location by following turn-by-turn directions. This navigation platform can be automatically integrated with work orders for seamless navigation capabilities. Additional GIS data layers and specific mapping data can also be displayed on the devices. In-vehicle navigation flexibility has the added benefit of saving time for office staff as they do not need to give directions over the phone or spend time helping lost field operators.

System 10 (and in particular WMS 40) may further comprise:
Planning grid web portal: A planning grid that shows the work and work orders; each party may have their own planning grid or their own information displayed on planning grid when they are accessing it. For agency 2 it may show all of their work orders (entered either directly via FSS 40 or manually or automatically via ERP system), some of the work orders they can choose to dispatch to MCD's 14 and some of which they can choose to dispatch (assign) to a TPP 4. For TPP, items assigned to the TPP appear on the TPP Planning Grid (within FSS). The TPP can utilize whatever system they have in place for dispatching the work (radio, paper, email), but they submit the record of work via the Planning Grid interface. For Agency 2, the statuses of work orders (assigned to TPP or their own MCDs 14) are updated in their system as if the work was completed by one of their own trucks. Planning grid may have user interface elements to allow agency contractor 4 to enter the relevant data required to complete a work order, and thus receive payment from agency 2. Planning grid may be viewed at any time during the processing of a work order; each party that is a party for a particular work order (e.g. it is their work order or they are performing it) is able to see some portion of the work order data, or assigned work order data (work order data that TPP 4 was able to see, which may be a subset of the original work order data and which may be added to as the work order is processed by TPP 4) based on, for example, user access rules and their relationship to the work order. For example, agency 2 may see all work order data (optionally including amendments as they are made by TPP 4) while TPP 4 may only see assigned work order data.
Mapping engine: Mapping engine may be a data mapping tool to translate data and information from one system to another (such as ERP Software 12 and ERP Software 22), from MCD 14 to WMS 40, from MCD 24 to WMS 40, from MCD 24 to ERP Software 22 and from planning grid to WMS 40). Mapping engine may comprise one or more mapping dictionaries that can translate between ERP systems (or other systems having different data elements for, for example, work orders).
User access engine: An engine to determine whether a requester can access a requested resource, and what permissions may accompany an acceptance. Exemplary requesters may include agency contractor 4 and agency 2. Requested resources may include the planning grid. Permissions or user access rules may vary for each requested resource and may be high-level (ability to log in) or granular (for a particular work order, or work order type, what fields should be obfuscated, locked, or editable for a particular requester). User access engine may affect what information may be viewed, by what party, on their planning grid or when they access the planning grid. Exemplary categories of work order data may include: viewable data in viewable data fields (that can be seen by TPP 4), editable data in editable data fields (that can be seen and edited by TPP 4), confidential data in confidential data fields (that may be obfuscated from TPP 4, potentially depending on which TPP 4 is involved and its access), and work order data in confidential fields (where TPP 4 is not to view the field or the data, so the field may be removed from the planning grid for TPP 4).

Third party provider (TPP, or agency contractor) may be another entity (other than the one running WMS 40) that performs field service. TPP may have different trust levels, reflecting the level of trust agency 2 has for TPP 4.

TPP 4 may have a third party provider system 22 which may comprise largely similar components to those of agency 2 or may have systems in place for the delivery of work to their driver/operators 26 (such as verbally through radio or cell phone communications, via email, via text messaging or simple paper transfer). For example TPP 4 may have a FMS 22 that may be similar to FMS12 (and may be from the same provider as FMS 12), TPP operator MCD 24 may be substantially similar to MCD 14, operator 16 may be substantially similar to TPP operator 26, fleet vehicle 18 may be substantially similar to TPP fleet vehicle 28, and the like. Components may be provided by different manufacturers and/or have different software components therein, for example. TPP system 22 may communicate via communication network 30, which may be any network, or combinations of networks, known to those of skill in the art, and may be the same or different from communication network 30 used by MCD 14 to communicate with WMS 40. In one embodiment TPP Dispatcher 34 accesses the work order information that they are authorized to view from Agency 2 via WMS/FSS 40 (accessed via the Internet 30). TPP 4 utilizes whatever systems that they have in place to deliver the work order. TPP Dispatcher 34 updates the work order information as they receive notification of its completion from the TPP driver/operators 26 for synchronization back to Agency 2 via WMS/FSS 40.

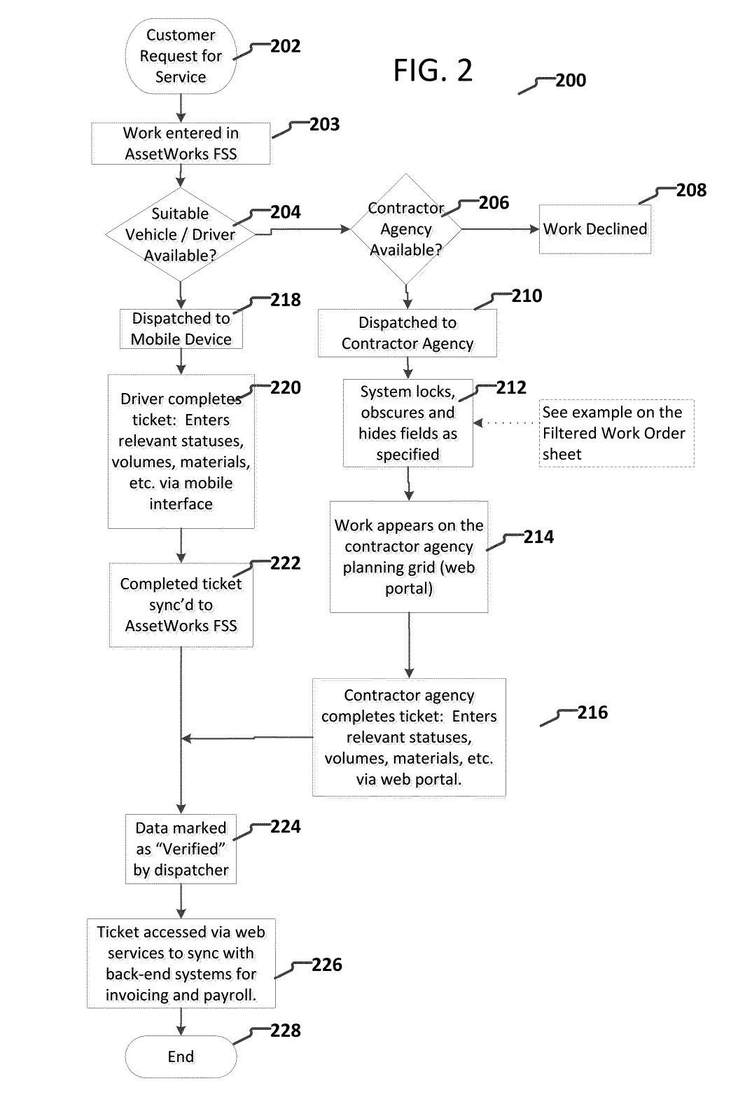

FIG. 2 is a diagram of a method 200 for trusted agent work order processing for mobile workforce management systems.

Method 200 may allow contractor agency 4 to perform a work order for agency 2 and complete the collection and entry of work order data via the planning grid.

Method 200 begins at 202 where a request for customer service is received. The request is entered at 203 where a work order is entered into WMS 40 (it should be noted that the work order may be entered in various ways, including by the Dispatcher 36 via the web interface, or by FMS 12 via Web Services). Method 200 then proceeds as such:
(a) At 204: Dispatcher 36 determines if there is a driver/operator and/or resource available to perform the required work order or field service. If so, method 200 continues a normal workflow;
(b) At 218: the work is entered into WMS 40 (directly or via ERP software 12), a work order is created and dispatched to MCD 14 (such as by dispatcher 36) for performance by an operator;
(c) At 220: the driver/operator completes the work order ticket, via their MCD 14, for example by entering relevant work order data (such as statuses of the work or assets, volumes, materials used or available, and any other information about the job or field service requested);
(d) At 222: the completed work order or ticket is synchronized with WMS 40 from MCD 14.
(e) At 224: a dispatcher 36 or other employee of agency 2 may verify the work order data entered;
(f) At 226: the ticket or work order may be accessed to synchronize with other systems such as ERP software 12 (payroll, HR, etc); and
(g) At 228: method 200 may end.

Returning to 204, if no resources are available then method continues at 206 to query whether a contractor agency 4 (or an independent mobile TPP operator for example) is available to perform the work order. If not then method 200 ends at 208.

If so, method 200 continues at 210. In method 200, TPP 4 may process work orders according to its own system (such as their own WMS or even pen and paper) and may enter the required data (which may be a subset of what it maintains) into planning grid. There may be many methods and factors to determine whether a TPP 4 is available, such as schedule-based availability, performance levels, cost estimates, whether available TPPs 4 meet any requirements that may be imposed by the party (customer or agency 2) for whom the work order is being done, and the like.

At 210 the work order is assigned/dispatched to TPP 4. Assigning may involve, for example, making the work order accessible via the particular planning grid for, or accessible by, TPP 4.

At 212 WMS 40 tailors the work order being assigned, for example by locking certain fields from editing, obscuring values of some fields (such that the fields are visible but the values are not) and/or entirely removing fields from being displayed. This may be at least partially accomplished using the user access engine. This also may be at least partially accomplished by designating each field as having a particular attribute that, depending on the user access level of TPP 4, may be handled by locking, obscuring values, or removing—thus allowing WMS and planning grid to simply display the work order data according to the designated attributes.

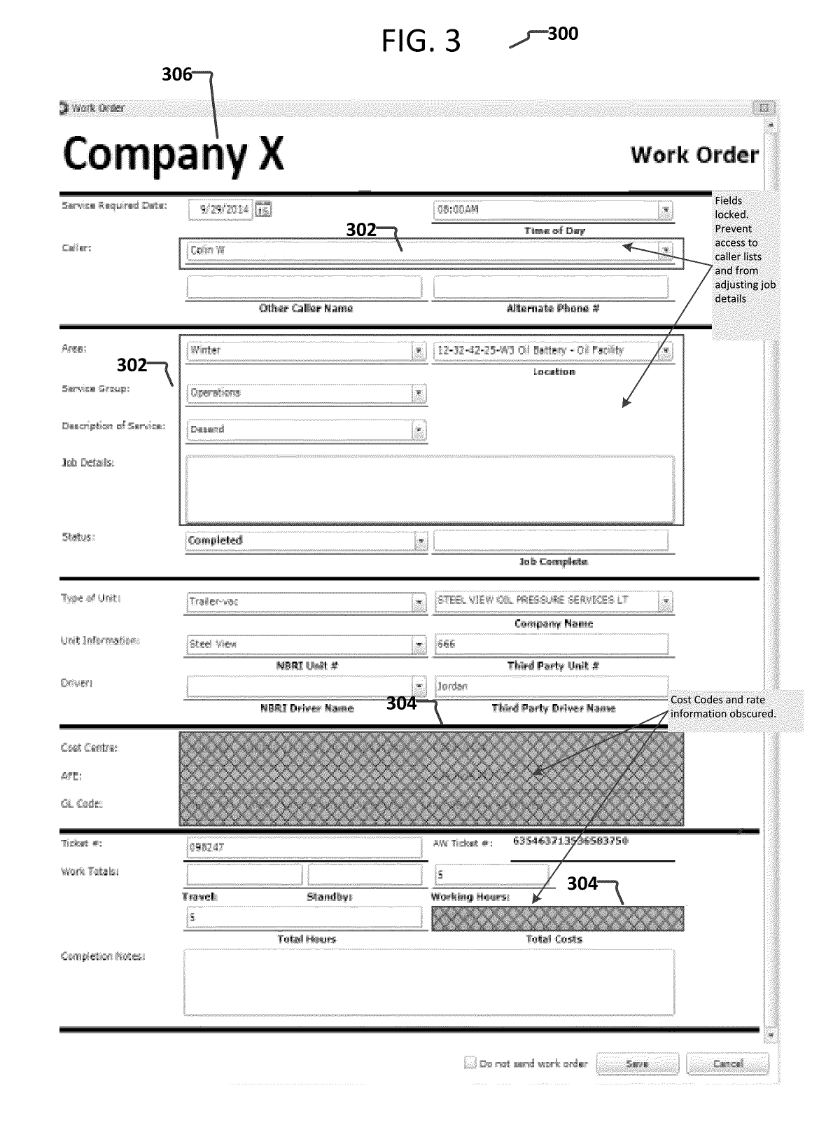

In one embodiment, and as shown on screenshot 300 in FIG. 3, fields 302 that are circled may be locked (e.g. locked fields 302), fields 304 where the values are “greyed out” may be obscured value fields 304, and there may also be some missing or removed fields. TPP Dispatcher 34 from agency 4 will only have access to the required work order information to understand the service requirements, assign the work and update statuses. Note that screenshot relates to Company X 306, which may be agency 4.

Method 200 then continues to 214 where the work order may appear on the contractor agency planning grid (which may cause it be registered as a work order to be performed and that may be then assigned to one or more of its mobile operators or may lead dispatcher 34 to initiate workflows, independent from planning grid, to effect the required work specified on the planning grid).

At 216 the ticket is completed by contractor agency by entering relevant information. It should be noted that contractor agency itself may enter information or it may be entered, directly or indirectly via MCD 24 by TPP operator 26—for example depending on the relation between TPP 4 workflows and use of the planning grid.

Method 200 may then proceed to 224, which may be as described herein, provided that if coming from 216 data verification may be from an external source so it may receive increased scrutiny (and may be identified as externally entered data so as to receive such further scrutiny).

Various types of completion of a work order may occur—for example when the work is completed, when the operator has properly entered the required data, when the data has been verified (by TPP 4 and/or agency 2), and when all parts of system 10 have the final data required (including, for example, ERP software). For security purposes the planning grid may be updated to restrict access at the correct stage of completion—for example with TPP 4 no longer having access to work order data or assigned work order data after agency 2 has verified the assigned work order data (and/or amended assigned work order data) from TPP 4.

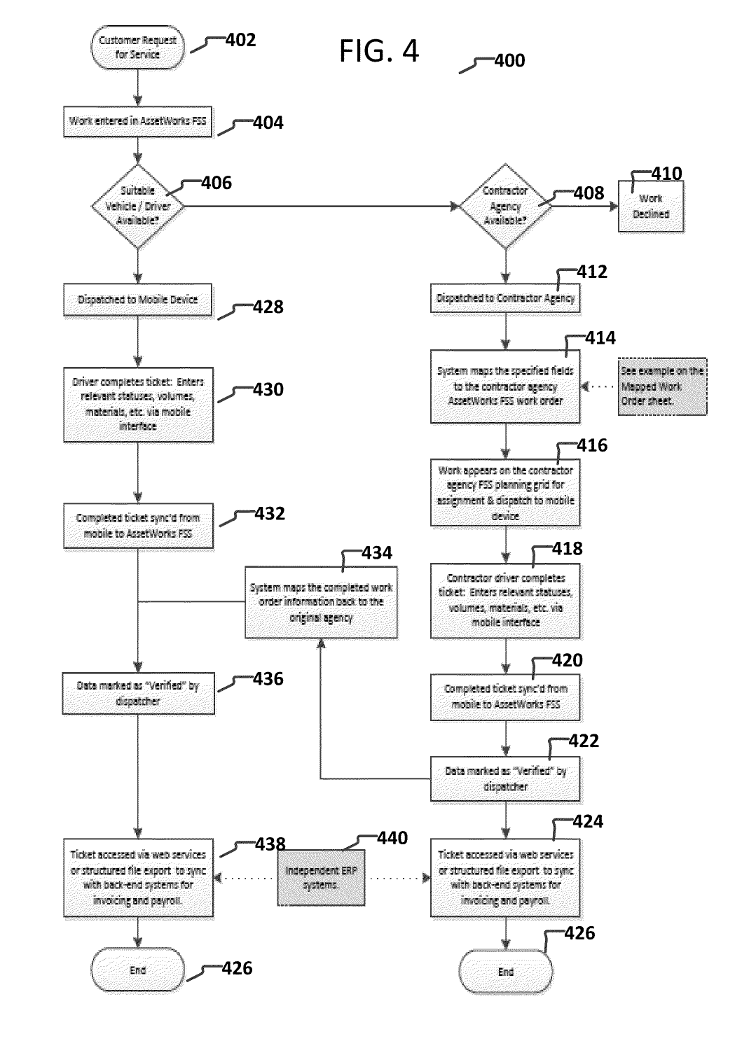

FIG. 4 is a diagram of a further method for trusted agent work order processing for mobile workforce management systems.

Method begins at 402, which may be similar to 202. At 404 the work order may be entered into WMS 40 (though it may be entered after 406, as in method 200).

At 406 a similar query to 204 is made. If there are resources then method 400 may follow a normal workflow:
(a) At 428: The work order may be dispatched to MCD 14, as described herein.
(b) At 430: May be substantially similar to 220.
(c) At 432: May be substantially similar to 222.
(d) At 434: May be substantially similar to 224.
(e) At 436: May be substantially similar to 226.
(f) At 426: May be substantially similar to 228.

Returning to 406, if no resources are available then 408 and 410 may be substantially similar to 206 and 208.

If TPP 4 is available then at 412 the work order is dispatched to contractor agency 4, as described herein. Method 400 may occur when TPP 4 is using some form of electronic Fleet Management Software (such as FMS 22 which may be from a different manufacturer than FMS 12 that is used by Agency 2). The process is dependent on TPP 4 utilizing WMS 40 for the management and delivery of work order data to driver/operators 26.

At 414 WMS 40 maps the specified or required fields from the work order (agency work order) to contractor agency work order. This may be performed by mapping engine and may involve invoking a translator/mapper specifically designed for the combination contemplated (of agency work order and contractor agency work order). Fields required for mapping may be those marked as required in a work order template in mapping engine and may be based on required fields for the particular work order, or that may be enforced on one party by another (e.g. agency 2 may require a ‘delta’ odometer reading despite a reading not being required or not being called odometer reading but distance travelled). In addition, by potentially having fully independent views on the work order, TPP 4 may include information that is critical to work order processing by their FMS 22. Agency 2 may have an entirely different FMS 12 and may include entirely different information. For example, Agency 2 may need to track the authority for expenditure (AFE) associated with a work order, while TPP Agency 4 tracks purchase orders.

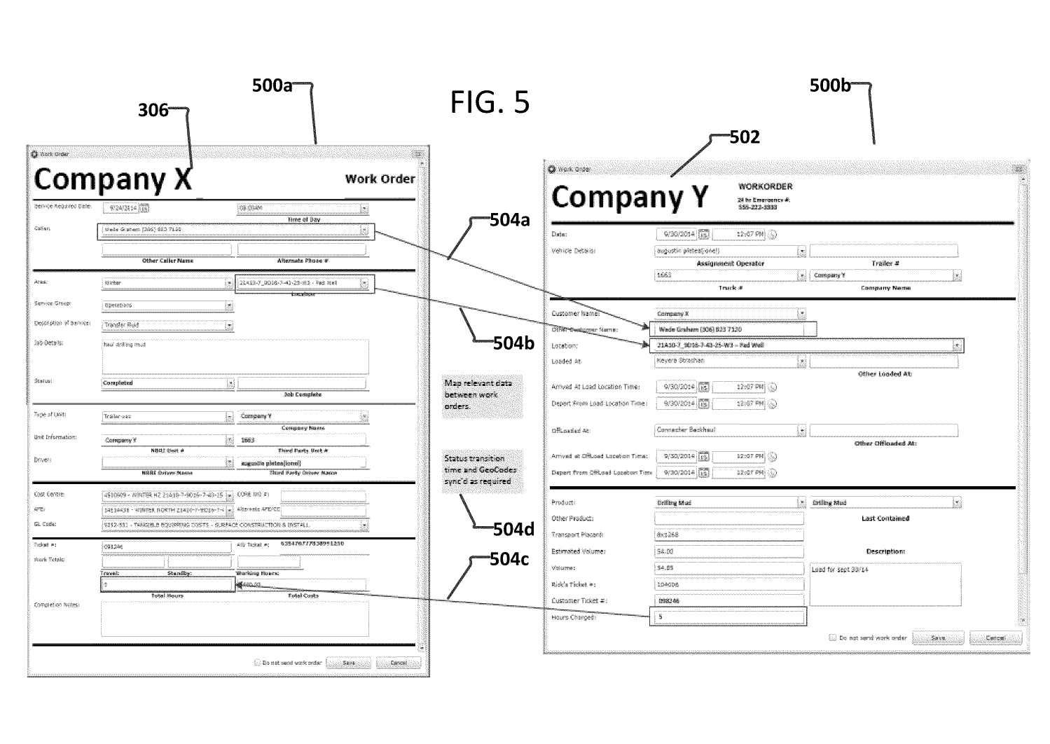

One example of such mapping is found in screenshots 500a and 500b in FIG. 5. Screenshot 500a is the dispatcher 36 view of the agency work order for Company X 306 which may be agency 2 and screenshot 500b is the TPP dispatcher 34 view of the work order re-mapped for TPP 4 operations for Company Y 502 which may be TPP 4.

As can be seen at 504a, 504b, 504c and 504d there are several fields that need to be mapped from agency work order to TPP work order. Some mappings may be simple (such as 504a and 504b) where the field names are essentially the same and their locations within the particular work order are quite similar. Complex mappings may also exist, such as 504c, where the field name requires mapping (“Total Hours” to “Hours Charged”) and locations may be different. Mappings and updating may also occur upon submission or completion of a work order or may be specified as requiring real-time mapping and updating, such as 504d where “status transition time and GeoCodes sync'd as required”—GeoCodes of vehicles and transition times (where aspects of performance of the work order change) may be updated frequently or substantially in real-time.

Method 400 continues at 416, which may be similar to 214 with the work order being added to a planning grid for assignment to MCD 24 of operator 26.

At 418 TPP operator 26 that was assigned the work order completes the work order and provides the required data. At 420 such data is synchronized back to WMS 40 from MCD 24. It can be viewed by the TPP dispatcher 34 on the planning grid and optionally consumed via web services by FMS 22. Contractor agency 4 may then perform data validation and verification (at step 422) before, at 434 data entered for the work order (either by TPP dispatcher 34 manual entry into the planning grid or TPP operator/driver 26 entries via MCD24), is mapped by WMS 40 as required by Agency 2.

At this point there may be two streams of processing, one at agency 2 and one at contractor agency 4. At agency 2 data may be verified again by dispatcher 36, at 436 (and as described herein for external data) and method 400 may proceed to 438. At contractor agency 4 method 400 may proceed at 424, which may be substantially similar to 438 but at contractor agency 4—and noting that such systems (HR, ERP, etc) 440 may be separate from those of agency 2.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A system for securing confidential data during contractor agency performance of work orders on behalf of an agency where such work orders comprise viewable data in viewable data fields, editable data in editable data fields, confidential data in confidential data fields, and work order data in confidential fields, the system comprising:
a contractor agency planning grid viewable by a contractor agency via a contractor agency fleet management system and configured to display an assigned work order from a workforce management system; and
the workforce management system comprising a processor configured to:
check whether the contractor agency can perform a work order;
assign the work order to the contractor agency planning grid, comprising creating the assigned work order from the work order if the contractor agency can perform the work order, the creating further comprising:
sending viewable data in viewable data fields and editable data in editable data fields to the contractor agency planning grid;
obfuscating confidential data in confidential data fields on the contractor agency planning grid; and
removing work order data in confidential fields from the contractor agency planning grid.

2. The system of claim 1 wherein the contractor agency planning grid is further configured to receive modifications to the assigned work order; and the workforce management system is further configured to verify the modifications to the assigned work order, and amend the work order by conforming it to the assigned work order.

3. The system of claim 1 wherein when the work order is noted as completed, further viewing of the work order is limited.

4. The system of claim 3 wherein, prior to the work order is noted as completed, the work order and the assigned work order are displayed according to user access rules.

5. The system of claim 1 wherein the workforce management system is further configured to map the work order to the assigned work order via one or more work order mapping dictionaries.

6. A method for securing confidential data during contractor agency performance of work orders on behalf of an agency, the work orders comprise viewable data in viewable data fields, editable data in editable data fields, confidential data in confidential data fields, and work order data in confidential fields, the method comprising:
checking whether a contractor agency can perform a work order;
displaying the work order on a contractor agency planning grid viewable by the contractor agency via a contractor agency fleet management system, via creating an assigned work order from the work order, if the contractor agency can perform the work order, the creating further comprising:
sending viewable data in viewable data fields and editable data in editable data fields to the contractor agency planning grid;
obfuscating confidential data in confidential data fields on the contractor agency planning grid; and
removing work order data in confidential fields from the contractor agency planning grid.

7. The method of claim 6 further comprising:
receiving modifications to the assigned work order;
verifying the modifications to the assigned work order; and
amending the work order by conforming it to the assigned work order.

8. The method of claim 6 further comprising noting the work order as completed and limiting further viewing of the work order.

9. The method of claim 6 further comprising:
displaying the status of the work order, prior to the noting, by displaying the work order or assigned work order according to user access rules.

10. The method of claim 6 wherein the creating comprises mapping the work order to the assigned work order via one or more work order mapping dictionaries.
